(19) United States
(12) Patent Application Publication
(10) Pub. No.: US 2023/0042909 A1
(43) Pub. Date: Feb. 9, 2023

(54) SYSTEMS AND METHODS FOR GENERATING MEDIA MANIFESTS

(71) Applicant: META PLATFORMS TECHNOLOGIES, LLC, Menlo Park, CA (US)

(72) Inventor: Colleen Kelly Henry, Oakland, CA (US)

(21) Appl. No.: 17/396,465

(22) Filed: Aug. 6, 2021

(51) Int. Cl. H04L 29/06; H04N 21/845

(52) U.S. Cl. CPC H04L 65/607; H04N 21/8456

(57) ABSTRACT

A computer-implemented method for generating media manifests may include (i) identifying media files that include different versions of a media item, (ii) identifying manifest standards, where each manifest standard in the manifest standards specifies a format for manifests that list media files that meet predetermined requirements described in the manifest standard, (iii) receiving, from a client, a request for a manifest for the media item in a particular manifest standard, (iv) identifying a subset of the media files that meet the predetermined requirements described in the particular manifest standard, (v) generating a manifest for the media item that lists media files in the subset and does not list media files in the media files that are not in the subset, and (vi) transmitting, to the client, the manifest for the media item in the particular manifest standard. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for generating media manifests.

FIG. 2 is a flow diagram of an exemplary method for generating media manifests.

FIG. 3 is an additional flow diagram of an exemplary method for generating media manifests.

FIG. 4 is an illustration of exemplary media manifest specifications relating to codecs.

FIG. 5 is an illustration of an exemplary system for distributing media via media manifests.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

Features from any of the embodiments described herein may be used in combination with one another in accordance with the general principles described herein. These and other embodiments, features, and advantages will be more fully understood upon reading the following detailed description in conjunction with the accompanying drawings and claims.

### DETAILED DESCRIPTION OF EXEMPLARY EMBODIMENTS

The present disclosure is generally directed to systems and methods for generating manifests for sets of media files related to a media item. For example, a movie may be encoded with a number of different encoders at various different resolutions and/or qualities. In some examples, a client may request a manifest that describes the files so that the client can determine which files are available for download and request the files most relevant to the client (e.g., files at an appropriate resolution for the client’s display, files decodable by a decoder on the client, etc.). In some embodiments, different manifest standards may specify different types of files to list within manifests generated based on the manifest standard. For example, one manifest standard may not list files encoded with a certain codec. Because not all files may be applicable to every manifest standard, the systems described herein may maintain a list of all files and determine which subset of the files are applicable to each manifest standard. In some embodiments, the systems described herein may generate manifests in response to client requests (e.g., on the fly). Additionally or alternatively, the systems described herein may pregenerate manifests for different manifest standards.

In some embodiments, the systems described herein may improve the functioning of a computing device by improving the ability of the computing device to generate media manifests. Additionally, the systems described herein may improve the fields of media distribution and/or media streaming by efficiently producing manifests for media files. In some embodiments, the systems described herein may increase the flexibility of the manifest generation process by automatically generating manifests based on manifest standards.

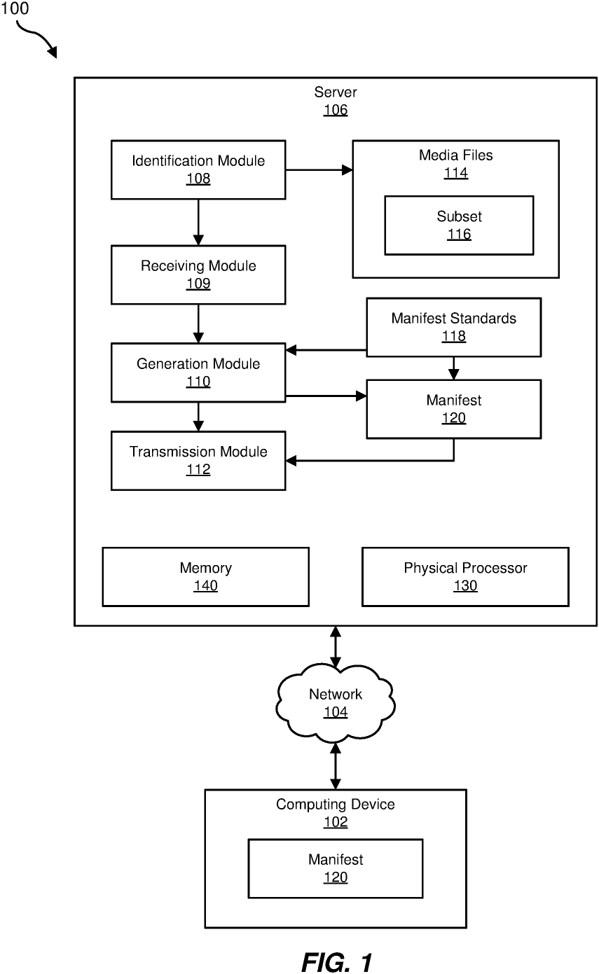

In some embodiments, the systems described herein may generate media manifests. FIG. 1 is a block diagram of an exemplary system 100 for generating media manifests. In one embodiment, and as will be described in greater detail below, a server 106 may be configured with an identification module 108 that may identify a plurality of media files 114 that include a plurality of different versions of a media item. Identification module 108 may also identify a plurality of manifest standards 118, where each manifest standard specifies a format for manifests that list media files that meet predetermined requirements described in the manifest standard. At some point in time, a receiving module 109 may receive, from a computing device 102, a request for a manifest 120 for the media item in a particular manifest standard. Either in response to the request or at a prior time, a generation module 110 may identify a subset of the plurality of media files 114 that meet the predetermined requirements described in the particular manifest standard may generate a manifest 120 for the media item that lists media files in the subset and does not list media files in the plurality of media files 114 that are not in the subset. Finally, a transmission module 112 may transmit, to computing device 102, manifest 120 for the media item in the particular manifest standard.

Server 106 generally represents any type or form of backend computing device that may host media files and/or manifests that describe media files. Examples of server 106 may include, without limitation, media servers, application servers, database servers, and/or any other relevant type of server. Although illustrated as a single entity in FIG. 1, server 106 may include and/or represent a group of multiple servers that operate in conjunction with one another.

Computing device 102 generally represents any type or form of computing device capable of reading computer-executable instructions. For example, computing device 102 may represent a personal computing device and/or endpoint computing device. Examples of computing device 102 may include, without limitation, a laptop, a desktop, a wearable device, a smart device, an artificial reality device, a personal digital assistant (PDA), etc.

Media files 114 generally represent any digital files that may be used to play and/or display a media item, such as a still image, an audio recording, a video recording, and/or an artificial reality experience. In some embodiments, media files 114 may include segments of a media item that can be reassembled to play the complete media item. For example, media files 114 may include time-bounded portions of an audio and/or video file (e.g., segments that are half a second long, two seconds long, five seconds long, etc.). In some embodiments, media files 114 may include encoded versions of a media item that are encoded via one or more encoders and are designed to be decoded by corresponding decoders before being played and/or displayed. In some examples, media files 114 may include different versions of a media item that are encoded to different resolutions and/or qualities (e.g., bit rates), include different language versions (e.g., of audio and/or captions), and/or include slightly different content (e.g., added scenes for a director’s cut, removed scenes due to regional censorship, etc.).

Manifest 120 generally represents any listing of media files associated with a media item that is generated and formatted according to a manifest standard. In some embodiments, manifest 120 may include details about media files including but not limited to file size, bit rate, resolution, codec, and/or content. In some examples, manifest 120 may also include listings of relevant files, such as subtitles and/or options. In some embodiments, manifest 120 may be formatted in a markup language, such as Extensible Markup Language (XML). The term “manifest standard” may generally represent any set of specifications for generating a manifest. In some examples, a manifest standard may include a specification for the file type of files listed in the manifest, one or more encoders that may be used to encode the files listed in the manifest, and/or one or more decoders that may be used to decode the files listed in the manifest. In one example, a manifest standard may include a specification for the formatting of the list of files in the manifest, such as the order in which to list files, the information to include about each file (e.g., size, type, content, etc.) and/or the format of this information. Examples of manifest standards may include, without limitation, Hypertext Transfer Protocol (HTTP) Live Streaming (HLS) and/or Dynamic Adaptive Streaming over HTTP (DASH). In some examples, a manifest standard may be a particular version of a manifest standard, such as HLS v4.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of the modules illustrated in FIG. 1. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of the modules stored in memory 140. Additionally or alternatively, physical processor 130 may execute one or more of the modules. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

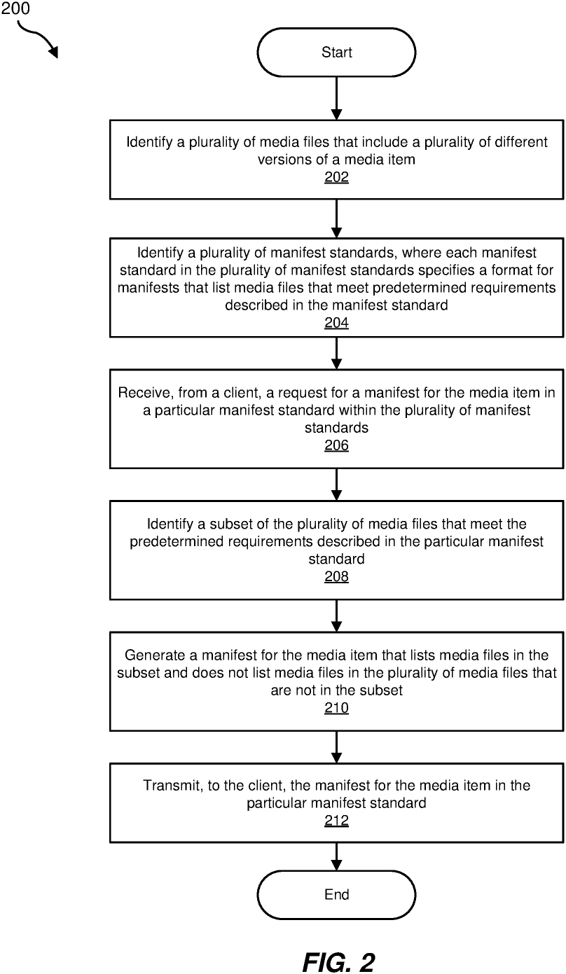

FIG. 2 is a flow diagram of an exemplary method 200 for generating media manifests. In some examples, at step 202, one or more of the systems described herein may identify a plurality of media files that include a plurality of different versions of a media item. For example, identification module 108 may, as part of server 106 in FIG. 1, identify a plurality of media files 114 that include a plurality of different versions of a media item.

Identification module 108 may identify the media files in a variety of ways. For example, identification module 108 may search a designated location (e.g., a server, a folder, etc.) for the files. Additionally or alternatively, identification module 108 may search for media files with a certain attribute and/or tag (e.g., tagged as relevant to the media item, having a filename that matches a certain pattern, etc.). In some embodiments, identification module 108 may receive user input, such as a location in which to search for the files, a tag to search for, an attribute to search for, and/or a list of files. In some embodiments, identification module 108 may periodically (e.g., once per hour, once per day, etc.) repeat the search for media files to discover new media files for the media item.

At step 204, one or more of the systems described herein may identify a plurality of manifest standards, where each manifest standard in the plurality of manifest standards specifies a format for manifests that list media files that meet predetermined requirements described in the manifest standard. For example, identification module 108 may, as part of server 106 in FIG. 1, identify a plurality of manifest standards 118, where each manifest standard in the plurality of manifest standards 118 specifies a format for manifests that list media files that meet predetermined requirements described in the manifest standard.

Identification module 108 may identify the manifest standards in a variety of ways. For example, identification module 108 may search a designated location (e.g., a server, a folder, etc.) for the manifest standards. Additionally or alternatively, identification module 108 may search for files of a certain file type (e.g., a file type used for manifest standards), with a certain attribute (e.g., a filename that matches a specified pattern), and/or with a certain tag (e.g., tagged as a manifest standard). In some embodiments, identification module 108 may receive user input, such as a location in which to search for the manifest standards, a tag to search for, an attribute to search for, a list of manifest standards, and/or a list of specifications that form a manifest standard. In some embodiments, identification module 108 may periodically (e.g., once per day, once per week, etc.) repeat the search for manifest standards to discover new standards.

At step 206, one or more of the systems described herein may receive, from a client, a request for a manifest for the media item in a particular manifest standard within the plurality of manifest standards. For example, receiving module 109 may, as part of server 106 in FIG. 1, receive, from a computing device 102, a request for manifest 120 for the media item in a particular manifest standard within the plurality of manifest standards 118.

Receiving module 109 may receive the request in a variety of ways and/or contexts. For example, receiving module 109 may receive the request as part of a request for the client to download the relevant media files. In another example, receiving module 109 may receive the request as part of a request for the client to stream the relevant media files. In some examples, receiving module 109 may receive a request that specifies a single manifest standard. In other examples, receiving module 109 may receive a request that specifies multiple acceptable manifest standards.

At step 208, one or more of the systems described herein may identify a subset of the plurality of media files that meet the predetermined requirements described in the particular manifest standard. For example, generation module 110 may, as part of server 106 in FIG. 1, identify a subset of the plurality of media files 114 that meet the predetermined requirements described in the particular manifest standard.

Generation module 110 may identify the subset of media files in a variety of contexts. For example, generation module 110 may identify the subset of media files in response to receiving module 109 receiving the request for the manifest. Additionally or alternatively, generation module 110 may identify the subset of media files while pre-generating manifests for the media item in various media standards.

At step 210, one or more of the systems described herein may generate a manifest for the media item that lists media files in the subset and does not list media files in the plurality of media files that are not in the subset. For example, generation module 110 may, as part of server 106 in FIG. 1, generate manifest 120 for the media item that lists media files in the subset and does not list media files in the plurality of media files 114 that are not in the subset.

Generation module 110 may generate the manifest in a variety of ways. For example, generation module 110 may compile a list of files in the subset and may then format the list of files according to the particular manifest standard. In some examples, generation module 110 may generate a manifest with placeholder files that can be specified later to provide customization for users.

At step 212, one or more of the systems described herein may transmit, to the client, the manifest for the media item in the particular manifest standard. For example, transmission module 112 may, as part of server 106 in FIG. 1, transmit, to computing device 102, manifest 120 for the media item in the particular manifest standard.

Transmission module 112 may transmit the manifest in a variety of ways. For example, transmission module 112 may reply to the client’s request for the manifest with the manifest. In some embodiments, transmission module 112 may transmit the manifest using a generic file transfer and/or messaging protocol, such as hypertext transfer protocol.

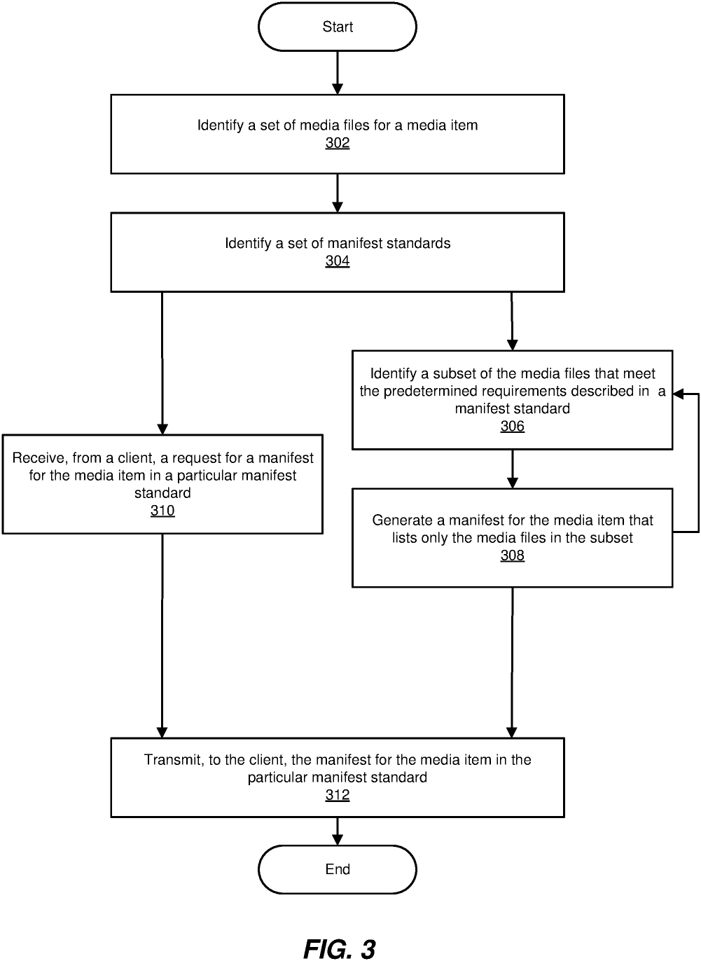

In some examples, the systems described herein may generate manifests before receiving a request for manifests and/or independently of receiving a request for a manifest. For example, as illustrated in FIG. 3, at step 302, the systems described herein may identify a set of media files for a media item. In one example, the systems described herein may identify a set of encoded segments for a movie. At step 304, the systems described herein may identify a set of manifest standards. For example, the systems described herein may identify a proprietary manifest standard used by a specific publisher and an open-source standard used by multiple publishers.

In some examples, at step 306, the systems described herein may identify a subset of the media files that meet the predetermined requirements described in a manifest standard. For example, the systems described herein may identify media files encoded by a proprietary codec used by the publisher of the proprietary manifest standard. At step 308, the systems described herein may generate a manifest for the media item that lists only the media files in the subset. For example, the systems described herein may generate a manifest formatted according to the proprietary manifest standard that lists and/or describes the files encoded by the proprietary codec. In some embodiments, the systems described herein may repeat steps 306 and 308 for each media standard in the set of manifest standards. For example, the systems described herein may next generate a manifest for the open-source manifest standard. In some embodiments, the systems described herein may detect when a new manifest standard is added to the set of manifest standards and may repeat steps 306 and 308 in response to detecting the new manifest standard.

In some example, at step 310, the systems described herein may receive, from a client, a request for a manifest for the media item in a particular manifest standard. In some embodiments, receiving the request may trigger the systems described herein to perform steps 306 and 308 for the particular manifest standard. Additionally or alternatively, the systems described herein may select a pre-generated manifest in the manifest standard in response to receiving the request from the client. In some embodiments, the systems described herein may modify the manifest to customize the manifest to the client, such as by including files for relevant advertisements rather than generic advertisements. At step 312, the systems described herein may transmit the manifest for the media item in the particular manifest standard to the client.

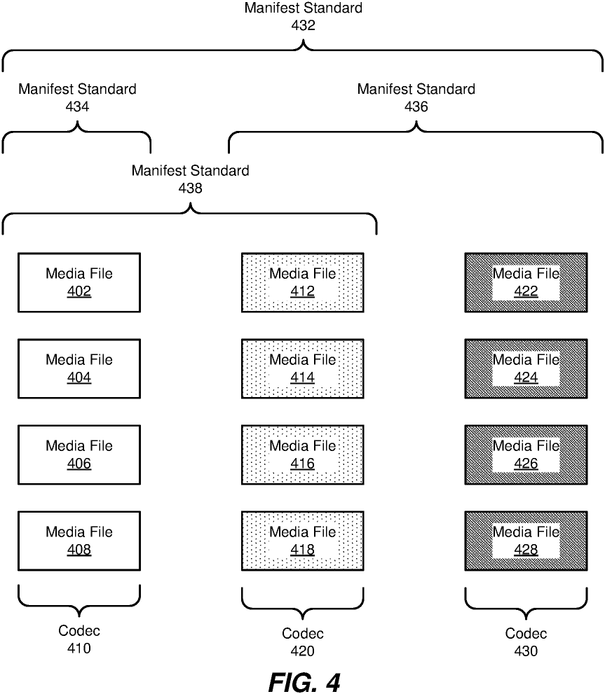

In some embodiments, different manifest standards may specify that media files be encoded with different codecs or sets of codecs. For example, as illustrated in FIG. 4, media files 402, 404, 406, and/or 408 may be encoded by a codec 410, media files 412, 414, 416, and/or 418 may be encoded by a codec 420, and/or media files 422, 424, 426, and/or 428 may be encoded by a codec 430. In one example, a manifest standard 432 may accept files encoded in all three codecs and the systems described herein may list media files 402, 404, 406, 408, 412, 414, 416, 418, 422, 424, 426, and/or 428 in a manifest for manifest standard 432. However, a manifest standard 434 may only accept files encoded in codec 410 and as a result, the systems described herein may list media files 402, 404, 406, and/or 408 in a manifest for manifest standard 434 but may not list any of the other media files. Similarly, a manifest standard 436 may accept media files encoded with codec 420 or codec 430 but not codec 410, and as a result, the systems described herein may list all media files except media files 402, 404, 406, and/or 408 in a manifest for manifest standard 436.

In some embodiments, if the systems described herein detect a new manifest standard, the systems described herein may generate a manifest based on the new manifest standard. For example, if the systems described herein detect a manifest standard 438 that lists files encoded with codecs 410 and 420 but not codec 430, the systems described herein may generate a manifest for manifest standard 438 that lists the files encoded with codecs 410 and 420 but not the files encoded with codec 430.

In some examples, if a manifest standard is updated to include more codecs, the systems described herein may efficiently update the manifest generated according to that manifest standard because the systems described herein already maintain a list of the files encoded using those codecs. For example, the HLS manifest standard, when released, did not support the H.265 codec. The HLS standard was later updated to support H.265. In this example, the systems described herein may re-generate an HLS manifest to include files encoded in H.265. In another example, the DASH manifest standard is codec-independent. In this example, if the systems described herein identify new media files encoded using a new codec, the systems described herein may update a DASH manifest to include the new media files. Additionally or alternatively, the systems described herein may generate a manifest using the new version of the manifest standard while maintaining a version of the manifest generated with the prior version of the manifest standard.

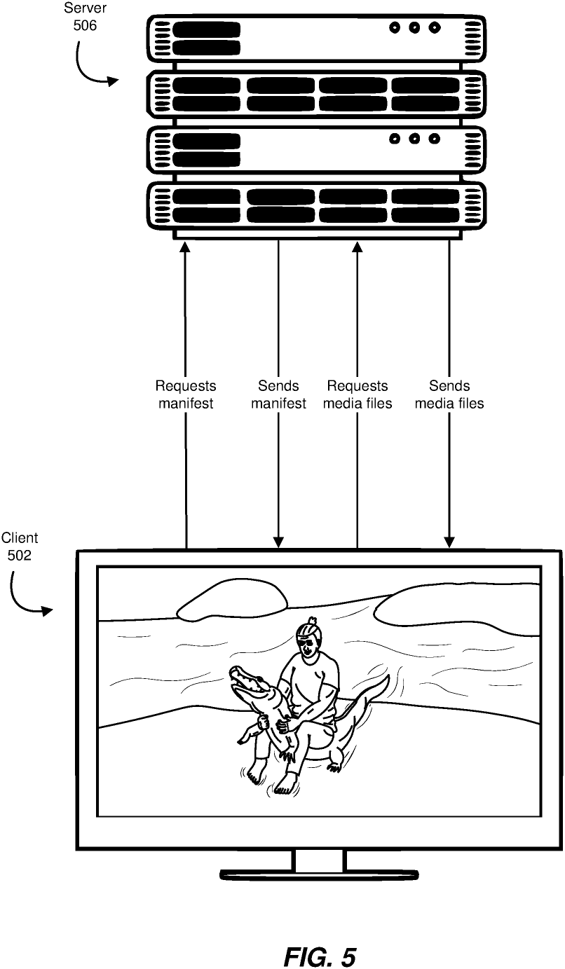

In some embodiments, the systems described herein may be part of a hosting and/or distribution system for streaming and/or downloadable media. For example, as illustrated in FIG. 5, a client 502 may request a manifest for a media item from a server 506. For example, a smart television may request a manifest for a critically acclaimed documentary about alligator wrestling from a media distribution server. In one example, server 506 may sent client 502 a manifest that lists the media files that are available for the alligator-wrestling documentary. In some examples, client 502 may then request the specific media files that are relevant to client 502, such as media files that are the correct resolution for the screen of client 502 and decodable by a codec installed on client 502. In one example, server 506 may send the media files requested by client 502 and client 502 may then play the media item.

As described above, the systems and methods described herein may automatically generate media manifests for a media item according to various manifest standards by maintaining a list of relevant media files and generating manifests that list the subset of relevant media files applicable to each manifest standard. By automatically generating media manifests, the systems described herein may enable media distribution systems to efficiently adapt to new or changing manifest standards as well as to new or changing media files.

Additionally, by maintaining a global list of relevant files from which to generate manifests, the systems described herein may increase the flexibility of media distribution systems to upgrade to newer manifest standards with broader specifications for file characteristics without requiring re-organization or re-identification of relevant media files. In some embodiments, the systems described herein may maintain a list of media files that is broader than those relevant to current manifest standards. For example, a recorded artificial reality game stream may be available in high-resolution volumetric video and low-resolution two-dimensional video and the systems described herein may maintain a list of all relevant files, even though high-resolution volumetric video files may not be included in current manifest standards, in preparation for transmitting the files relevant to the client (e.g., volumetric for an artificial reality headset and two-dimensional for a smartphone) once a manifest standard enables this process. In some examples, the systems described herein may store models and positioning data for a game engine as media files to facilitate sending those files to a client has a game engine capable of rendering visuals based on models. In one embodiment, the systems described herein may maintain a list of files relevant to playing the media files, such as the address of a web-based media player, an installer for a codec, and/or any other relevant file that may enable a client to play a media file.

### Example Embodiments

Example 1: A method for generating media manifests may include (i) identifying a plurality of media files that include a plurality of different versions of a media item, (ii) identifying a plurality of manifest standards, where each manifest standard in the manifest standards specifies a format for manifests that list media files that meet predetermined requirements described in the manifest standard, (iii) receiving, from a client, a request for a manifest for the media item in a particular manifest standard within the manifest standards, (iv) identifying a subset of the media files that meet the predetermined requirements described in the particular manifest standard, (v) generating a manifest for the media item that lists media files in the subset and does not list media files in the media files that are not in the subset, and (vi) transmitting, to the client, the manifest for the media item in the particular manifest standard.

Example 2: The computer-implemented method of example 1, where the media files that include the different versions of the media item include a plurality of different encodings of the media item and the predetermined requirements described in the particular manifest standard specify a subset of the different encodings.

Example 3: The computer-implemented method of examples 1-2, where the media files that include the different versions of the media item include a plurality of sets of segments of the media item, where each set of segments includes segments of a specific length and the predetermined requirements described in the particular manifest standard specify at least one segment length.

Example 4: The computer-implemented method of examples 1-3, where the media files that include the different versions of the media item include a plurality of versions of the media item encoded at different resolutions.

Example 5: The computer-implemented method of examples 1-4, where the media files that include the different versions of the media item include a plurality of versions of the media item in different languages.

Example 6: The computer-implemented method of examples 1-5, where identifying the subset of the media files that meet the predetermined requirements described in the particular manifest standard includes, for each manifest standard in the manifest standards, identifying a subset of the media files that meet the predetermined requirements described in the manifest standard and generating the manifest for the media item that lists media files in the subset and does not list media files in the media files that are not in the subset includes generating, for each manifest standard in the standards, a manifest.

Example 7: The computer-implemented method of examples 1-6, where transmitting, to the client, the manifest for the media item in the particular manifest standard may include selecting an appropriate manifest from a pre-generated set of manifests.

Example 8: The computer-implemented method of examples 1-7, where generating the manifest for the media item that lists media files in the subset and does not list media files in the media files that are not in the subset may include generating the manifest on the fly in response to receiving the request for the manifest from the client.

Example 9: The computer-implemented method of examples 1-8 may further include (i) detecting an additional media file that includes a version of the media item, (ii) identifying at least one manifest standard for which the additional media file meets the predetermined requirements described in the manifest standard, and (iii) updating a manifest specified in the at least one manifest standard to list the additional media file.

Example 10: A system for generating media manifests may include at least one physical processor and physical memory including computer-executable instructions that, when executed by the physical processor, cause the physical processor to (i) identify a plurality of media files that include a plurality of different versions of a media item, (ii) identify a plurality of manifest standards, where each manifest standard in the manifest standards specifies a format for manifests that list media files that meet predetermined requirements described in the manifest standard, (iii) receive, from a client, a request for a manifest for the media item in a particular manifest standard within the manifest standards, (iv) identify a subset of the media files that meet the predetermined requirements described in the particular manifest standard, (v) generate a manifest for the media item that lists media files in the subset and does not list media files in the media files that are not in the subset, and (vi) transmit, to the client, the manifest for the media item in the particular manifest standard.

Example 11: The system of example 10, where the media files that include the different versions of the media item include a plurality of different encodings of the media item and the predetermined requirements described in the particular manifest standard specify a subset of the different encodings.

Example 12: The system of examples 10-11, where the media files that include the different versions of the media item include a plurality of sets of segments of the media item, where each set of segments includes segments of a specific length and the predetermined requirements described in the particular manifest standard specify at least one segment length.

Example 13: The system of examples 10-12, where the media files that include the different versions of the media item include a plurality of versions of the media item encoded at different resolutions.

Example 14: The system of examples 10-13, where the media files that include the different versions of the media item include a plurality of versions of the media item in different languages.

Example 15: The system of examples 10-14, where identifying the subset of the media files that meet the predetermined requirements described in the particular manifest standard includes, for each manifest standard in the manifest standards, identifying a subset of the media files that meet the predetermined requirements described in the manifest standard and generating the manifest for the media item that lists media files in the subset and does not list media files in the media files that are not in the subset includes generating, for each manifest standard in the standards, a manifest.

Example 16: The system of examples 10-15, where transmitting, to the client, the manifest for the media item in the particular manifest standard may include selecting an appropriate manifest from a pre-generated set of manifests.

Example 17: The system of examples 10-16, where generating the manifest for the media item that lists media files in the subset and does not list media files in the media files that are not in the subset may include generating the manifest on the fly in response to receiving the request for the manifest from the client.

Example 18: The system of examples 10-17 may further include (i) detecting an additional media file that includes a version of the media item, (ii) identifying at least one manifest standard for which the additional media file meets the predetermined requirements described in the manifest standard, and (iii) updating a manifest specified in the at least one manifest standard to list the additional media file.

Example 19: A non-transitory computer-readable medium may include one or more computer-readable instructions that, when executed by at least one processor of a computing device, cause the computing device to (i) identify a plurality of media files that include a plurality of different versions of a media item, (ii) identify a plurality of manifest standards, where each manifest standard in the manifest standards specifies a format for manifests that list media files that meet predetermined requirements described in the manifest standard, (iii) receive, from a client, a request for a manifest for the media item in a particular manifest standard within the manifest standards, (iv) identify a subset of the media files that meet the predetermined requirements described in the particular manifest standard, (v) generate a manifest for the media item that lists media files in the subset and does not list media files in the media files that are not in the subset, and (vi) transmit, to the client, the manifest for the media item in the particular manifest standard.

Example 20: The computer-readable medium of example 19, where the media files that include the different versions of the media item include a plurality of different encodings of the media item and the predetermined requirements described in the particular manifest standard specify a subset of the different encodings.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive image data to be transformed, transform the image data into a data structure that stores user characteristic data, output a result of the transformation to select a customized interactive ice breaker widget relevant to the user, use the result of the transformation to present the widget to the user, and store the result of the transformation to create a record of the presented widget. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A computer-implemented method comprising:
identifying a plurality of media files that comprise a plurality of different versions of a media item;
identifying a plurality of manifest standards, wherein each manifest standard in the plurality of manifest standards specifies a format for manifests that list media files that meet predetermined requirements described in the manifest standard;
receiving, from a client, a request for a manifest for the media item in a particular manifest standard within the plurality of manifest standards;
identifying a subset of the plurality of media files that meet the predetermined requirements described in the particular manifest standard;
generating, in a format specified by the particular manifest standard, a manifest for the media item that lists media files in the subset and does not list media files in the plurality of media files that are not in the subset; and
transmitting, to the client, the manifest for the media item in the particular manifest standard.

2. The computer-implemented method of claim 1, wherein:
the plurality of media files that comprise the plurality of different versions of the media item comprise a plurality of different encodings of the media item; and
the predetermined requirements described in the particular manifest standard specify a subset of the plurality of different encodings.

3. The computer-implemented method of claim 1, wherein:
the plurality of media files that comprise the plurality of different versions of the media item comprise a plurality of sets of segments of the media item, wherein each set of segments comprises segments of a specific length; and
the predetermined requirements described in the particular manifest standard specify at least one segment length.

4. The computer-implemented method of claim 1, wherein the plurality of media files that comprise the plurality of different versions of the media item comprise a plurality of versions of the media item encoded at different resolutions.

5. The computer-implemented method of claim 1, wherein the plurality of media files that comprise the plurality of different versions of the media item comprise a plurality of versions of the media item in different languages.

6. The computer-implemented method of claim 1, wherein:
identifying the subset of the plurality of media files that meet the predetermined requirements described in the particular manifest standard comprises, for each manifest standard in the plurality of manifest standards, identifying a subset of the plurality of media files that meet the predetermined requirements described in the manifest standard; and
generating the manifest for the media item that lists media files in the subset and does not list media files in the plurality of media files that are not in the subset comprises generating, for each manifest standard in the plurality of standards, a manifest.

7. The computer-implemented method of claim 1, wherein transmitting, to the client, the manifest for the media item in the particular manifest standard comprises selecting an appropriate manifest from a pre-generated set of manifests.

8. The computer-implemented method of claim 1, wherein generating the manifest for the media item that lists media files in the subset and does not list media files in the plurality of media files that are not in the subset comprises generating the manifest on the fly in response to receiving the request for the manifest from the client.

9. The computer-implemented method of claim 1, further comprising:
detecting an additional media file that comprises a version of the media item;
identifying at least one manifest standard for which the additional media file meets the predetermined requirements described in the manifest standard; and
updating a manifest specified in the at least one manifest standard to list the additional media file.

10. A system comprising:
at least one physical processor;
physical memory comprising computer-executable instructions that, when executed by the physical processor, cause the physical processor to:
identify a plurality of media files that comprise a plurality of different versions of a media item;
identify a plurality of manifest standards, wherein each manifest standard in the plurality of manifest standards specifies a format for manifests that list media files that meet predetermined requirements described in the manifest standard;
receive, from a client, a request for a manifest for the media item in a particular manifest standard within the plurality of manifest standards;
identify a subset of the plurality of media files that meet the predetermined requirements described in the particular manifest standard;
generate, in a format specified by the particular manifest standard, a manifest for the media item that lists media files in the subset and does not list media files in the plurality of media files that are not in the subset; and
transmit, to the client, the manifest for the media item in the particular manifest standard.

11. The system of claim 10, wherein:
the plurality of media files that comprise the plurality of different versions of the media item comprise a plurality of different encodings of the media item; and
the predetermined requirements described in the particular manifest standard specify a subset of the plurality of different encodings.

12. The system of claim 10, wherein:
the plurality of media files that comprise the plurality of different versions of the media item comprise a plurality of sets of segments of the media item, wherein each set of segments comprises segments of a specific length; and
the predetermined requirements described in the particular manifest standard specify at least one segment length.

13. The system of claim 10, wherein the plurality of media files that comprise the plurality of different versions of the media item comprise a plurality of versions of the media item encoded at different resolutions.

14. The system of claim 10, wherein the plurality of media files that comprise the plurality of different versions of the media item comprise a plurality of versions of the media item in different languages.

15. The system of claim 10, wherein:
identifying the subset of the plurality of media files that meet the predetermined requirements described in the particular manifest standard comprises, for each manifest standard in the plurality of manifest standards, identifying a subset of the plurality of media files that meet the predetermined requirements described in the manifest standard; and
generating the manifest for the media item that lists media files in the subset and does not list media files in the plurality of media files that are not in the subset comprises generating, for each manifest standard in the plurality of standards, a manifest.

16. The system of claim 10, wherein transmitting, to the client, the manifest for the media item in the particular manifest standard comprises selecting an appropriate manifest from a pre-generated set of manifests.

17. The system of claim 10, wherein generating the manifest for the media item that lists media files in the subset and does not list media files in the plurality of media files that are not in the subset comprises generating the manifest on the fly in response to receiving the request for the manifest from the client.

18. The system of claim 10, wherein the computer-executable instructions cause the physical processor to:
detect an additional media file that comprises a version of the media item;
identify at least one manifest standard for which the additional media file meets the predetermined requirements described in the manifest standard; and
update a manifest specified in the at least one manifest standard to list the additional media file.

19. A non-transitory computer-readable medium comprising one or more computer-readable instructions that, when executed by at least one processor of a computing device, cause the computing device to:
identify a plurality of media files that comprise a plurality of different versions of a media item;
identify a plurality of manifest standards, wherein each manifest standard in the plurality of manifest standards specifies a format for manifests that list media files that meet predetermined requirements described in the manifest standard;
receive, from a client, a request for a manifest for the media item in a particular manifest standard within the plurality of manifest standards;
identify a subset of the plurality of media files that meet the predetermined requirements described in the particular manifest standard;
generate, in a format specified by the particular manifest standard, a manifest for the media item that lists media files in the subset and does not list media files in the plurality of media files that are not in the subset; and
transmit, to the client, the manifest for the media item in the particular manifest standard.

20. The computer-readable medium of claim 19, wherein:
the plurality of media files that comprise the plurality of different versions of the media item comprise a plurality of different encodings of the media item; and
the predetermined requirements described in the particular manifest standard specify a subset of the plurality of different encodings.
